(19) United States
(12) Patent Application Publication
(10) Pub. No.: US 2016/0145447 A1
(43) Pub. Date: May 26, 2016

(54) PLATED POLYMERS WITH INTUMESCENT COMPOSITIONS AND TEMPERATURE INDICATORS

(71) Applicant: UNITED TECHNOLOGIES CORPORATION, Farmington, CT (US)

(72) Inventors: Michael S. Miarecki, Enfield, CT (US); Grant O. Cook, Spring, TX (US); Wendell V. Twelves, Glastonbury, CT (US); Glenn Levasseur, Colchester, CT (US); Charles R. Watson, Windsor, CT (US)

(21) Appl. No.: 14/903,888

(22) PCT Filed: Jul. 9, 2014
(86) PCT No.: PCT/US14/46017

§ 371 Date: Jan. 8, 2016

Related U.S. Application Data
(60) Provisional application No. 61/844,108, filed on Jul. 9, 2013.

(51) Int. Cl. C09D 5/26; B32B 37/12; B05D 5/00; B05D 7/02; C23C 26/00

(52) U.S. Cl. CPC C09D 5/26; B05D 7/02; C23C 26/00; B05D 5/00; B32B 37/1284

(57) ABSTRACT

A plated polymer component is disclosed. The plated polymer component may comprise a polymer support, a metal plating deposited on a surface of the polymer support, and at least one flame-retardant additive included in the polymer support. In another aspect, the plated polymer component may comprise a polymer substrate, a metal plating deposited on a surface of the polymer substrate, and a temperature-indicating coating applied to at least one of of the polymer substrate.

### CROSS-REFERENCE TO RELATED APPLICATIONS

This application claims priority under 35 U.S.C. §119(e) to U.S. Provisional Patent Application Ser. No. 61/844,108 filed on Jul. 9, 2013.

### FIELD OF THE DISCLOSURE

The present disclosure generally relates to metal-plated polymer components having improved physical properties. More specifically, this disclosure relates to metal-plated polymer components having improved heat/flame resistance as well as temperature-indicating properties.

### BACKGROUND

Metal-plated and metal-coated polymer materials are attractive materials for component fabrication in many industries such as aerospace, automotive, and military equipment industries because they are lightweight and exhibit high specific strength. However, the strength and stiffness of metal-plated and metal-coated polymer materials may be dependent upon the integrity of the bond between the metal plating or coating and the underlying polymer substrate. In particular, the strength of the bonds formed between the metal plating and the underlying polymer substrate may be compromised upon exposure of the structure to temperatures above a critical temperature or a to a sufficient amount of thermal fatigue (thermal cycling or applied loads at elevated temperatures) during operation; in these cases, the integrity of the bond between the metal plating or coating and the polymer substrate may be at least partially degraded, which may lead to structural degradation of the component as well as possible in-service failure. Unfortunately, brief or minor exposures of metal-plated and metal-coated polymer components to high temperatures may go largely undetected in some applications. Even further, any resulting weakening of the bond between the metal-plating or metal-coating and the underlying polymer substrate may be difficult to detect. Clearly, enhancements are needed to improve the heat/flame resistance of metal-plated or metal-coated polymer components. Moreover, to ensure that metal-plated or metal-coated polymer components damaged by high-temperature exposure are removed from service in a timely manner, enhancements are also needed to assist in the detection of metal-plated or metal-coated polymer components that have been exposed to temperatures above their design limits.

### SUMMARY OF THE DISCLOSURE

In accordance with one aspect of the present disclosure, a plated polymer component is disclosed. The plated polymer component may comprise a polymer support and a metal plating deposited on a surface of the polymer support. The plated polymer component may further comprise at least one flame-retardant additive included in the polymer support.

In another refinement, the at least one flame-retardant additive may be an intumescent substance.

In another refinement, the intumescent substance may form a carbonaceous solid-phase char layer upon exposure to fire or a heat source. The carbonaceous layer may create a thermal barrier between the polymer support and the fire or the heat source.

In another refinement, the intumescent substance may be selected from the group consisting of phosphorous, melamine cyanurate, a nanoclay, and a nitrogen compound.

In another refinement, the intumescent substance may be present in the polymer support at a concentration in the range of about 5 wt. % to about 10 wt. %.

In another refinement, the polymer support may include a reinforcing element.

In another refinement, the intumescent substance may be present in the polymer support at a concentration of greater than about 10 wt. %.

In accordance with another aspect of the present disclosure, a plated polymer component is disclosed. The plated polymer component may comprise a polymer substrate and a metal plating deposited on a surface of the polymer substrate. The plated polymer component may further comprise a temperature-indicating coating applied to at least one of a surface of the metal plating and the surface of the polymer substrate.

In another refinement, the temperature-indicating coating may provide a detectable signal upon exposure of the plated polymer component to a critical temperature, and the critical temperature may be a temperature at which a bond between the polymer substrate and the metal plating begins to degrade.

In another refinement, the temperature-indicating coating may provide a detectable signal upon exposure of the plated polymer component to a critical temperature, and the critical temperature may be a glass-transition temperature of the polymer substrate.

In another refinement, the detectable signal may be a visually-detectable signal.

In another refinement, the visually-detectable signal may be a color change.

In another refinement, the visually-detectable signal may be a phase change.

In another refinement, the phase change may be a solid to liquid phase change.

In another refinement, the temperature-indicating coating may be a temperature-indicating paint.

In another refinement, the temperature-indicating coating may be a temperature-indicating film.

In accordance with another aspect of the present disclosure, a plated polymer component having a polymer substrate and a metal plating deposited on a surface of the polymer substrate is disclosed. The plated polymer component may be formed by a method comprising: 1) forming the polymer substrate, 2) depositing the metal plating on the surface of the polymer substrate, 3) selecting a temperature-indicating coating that provides a detectable signal at a critical temperature of a bond between the polymer substrate and the metal plating, and 4) applying the temperature-indicating coating to at least one of a surface of the metal plating and a surface of the polymer substrate.

In another refinement, the critical temperature may be a glass-transition temperature of the polymer substrate.

In another refinement, applying the temperature-indicating coating may comprise applying the temperature-indicating coating as a tape.

In another refinement, applying the temperature-indicating coating may comprise applying the temperature-indicating coating as a spray coating.

These and other aspects and features of the present disclosure will be more readily understood when read in conjunction with the accompanying drawings.

### BRIEF DESCRIPTION OF THE DRAWINGS

FIG. 1 is a perspective view of a heat-resistant component constructed in accordance with the present disclosure.

FIG. 2 is a cross-sectional view of the heat-resistance component of FIG. 1 taken along the line 2-2 of FIG. 1, constructed in accordance with the present disclosure.

FIG. 3 is a block diagram illustrating steps involved in the fabrication of the heat-resistant component, in accordance with a method of the present disclosure.

FIG. 4 is a front view of a plated polymer component having a temperature-indicating coating, constructed in accordance with the present disclosure.

FIG. 5 is a cross-sectional view of the plated polymer component of FIG. 4 taken along the line 5-5 of FIG. 4, constructed in accordance with the present disclosure.

FIG. 6 is a flow chart illustrating steps involved in the fabrication of plated polymer components having temperature-indicating coatings, in accordance with a method of the present disclosure.

It should be understood that the drawings are not necessarily drawn to scale and that the disclosed embodiments are sometimes illustrated schematically and in partial views. It is to be further appreciated that the following detailed description is merely exemplary in nature and is not intended to limit the invention or the application and uses thereof. In this regard, it is to be additionally appreciated that the described embodiment is not limited to use for certain applications. Hence, although the present disclosure is, for convenience of explanation, depicted and described as certain illustrative embodiments, it will be appreciated that it can be implemented in various other types of embodiments and in various other systems and environments.

### DETAILED DESCRIPTION

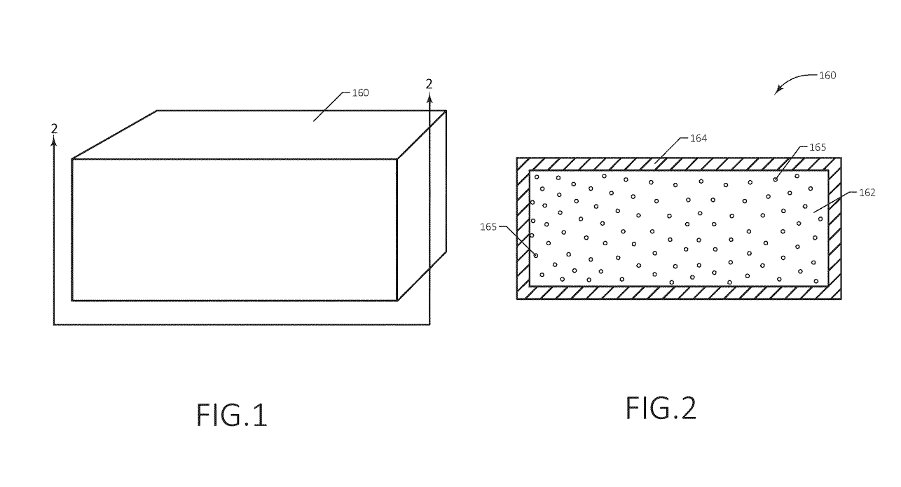

Referring now to FIGS. 1 and 2, a heat-resistant component 160 is shown. The heat-resistant component 160 may be lightweight and exhibit properties including high structural strength, flame resistance, and high-temperature stability. The heat-resistant component 160 may be employed as a structural or operative component suitable for use in a range of applications such as, but not limited to, gas turbine engine applications. As non-limiting examples, the heat-resistant component 160 may be a gas turbine engine duct or cover. As will be apparent to those of ordinary skill in the art, the structure of the heat-resistant component 160 may vary dramatically from the exemplary box-like structure depicted in FIGS. 1 and 2, depending on its application.

The heat-resistant component 160 may be a composite of a polymer support 162 and one or more metal platings 164 deposited on one or more of the outer surfaces of the polymer support 162, as best shown in FIG. 2. The metal plating 164 may structurally reinforce the component 160 and substantially increase its strength, without adding substantial weight to the component 160. Furthermore, the metal plating 164 may partially contribute to the heat-resistant properties of the component 160. The metal plating 164 may have a thickness of a between about 0.001 inches (about 0.0254 mm) to about 0.050 inches (about 1.27 mm), although other thicknesses may also apply. Moreover, the metal plating 164 may consist of one or metals selected from nickel, cobalt, copper, iron, gold, silver, palladium, rhodium, chromium, and alloys with any of the foregoing elements comprising at least 50 wt. % of the alloy, and combinations thereof

The polymer support 162 may be formed from a thermoplastic material or a thermoset material. Suitable thermoplastic materials may include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials may include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. Optionally, the polymer support 162 may also include one or more structurally reinforcing components such as carbon fibers, glass fibers, or structurally reinforcing nanomaterials.

Further included in the polymer support 162 may be one or more types of flame-retardant additives 165 which may resist the spread of fire. The flame retardant additives 165 may include any type of flame retardant such as, but not limited to, intumescent substances. Upon exposure to sufficient heat, the intumescent substances may resist the spread of fire by initiating the formation of a carbonaceous solid-phase char layer which may create a thermal barrier between the heat source and the underlying polymer support 162, thereby resisting the spread of burning throughout the polymer support material. The intumescent substances may be phosphorous, melamine cyanurate, nanoclays, nitrogen compounds, or any other intumescent substance, and may be present in the polymer support 162 at concentrations in the range of about 5 wt. % to about 10 wt. %. However, if structurally reinforcing components (carbon fibers, glass fibers, or structurally reinforcing nanomaterials) are present in the polymer support 162, then the concentration of the flame-retardant additive(s) 165 in the polymer support 162 may exceed 10 wt. %. In addition, the polymer support 162 may also optionally include one or more types of hydrated minerals which may release water in the presence of heat to cool, quench, and dilute the heat, thereby further protecting the materials forming the polymer support 162.

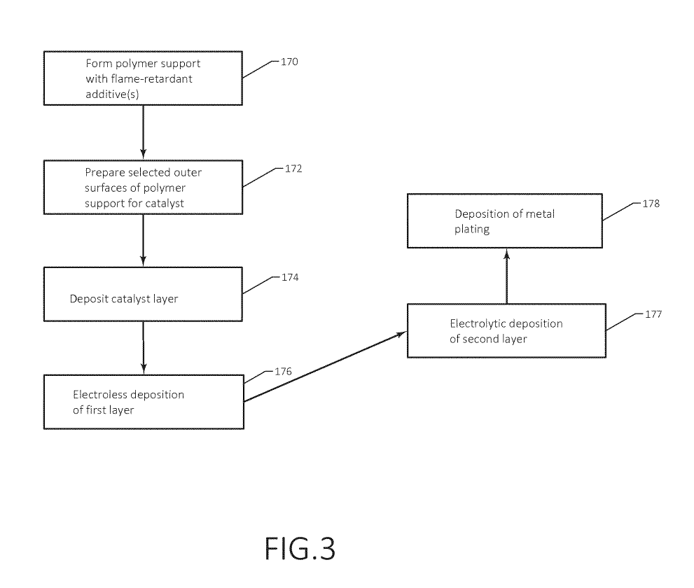

A series of steps which may be involved in the fabrication of the heat-resistant component 160 are depicted in FIG. 3. Beginning with a block 170, the polymer support 162 may be formed by adding the flame-retardant additive(s) 165 to the selected polymer materials (and optional fiber reinforcement materials) and then molding the polymer support 162 into a desired shape using one or more of various polymer molding processes apparent to those having ordinary skill in the art such as, but not limited to, injection molding, compression molding, blow molding, additive manufacturing (liquid bed, powder bed, deposition processes), or composite layup (autoclave, compression, or liquid molding).

Selected outer surface(s) of the polymer support 162 which are to be plated with the metal plating 164 may then be prepared for deposition of a catalyst according to a next block 172. Surface preparation may be achieved by etching, surface abrasion, ionic activation, or other similar processes to promote adhesion of a catalyst on the selected polymer support surface(s). According to a next block 174, a catalyst layer may then be deposited on the selected surfaces of the polymer support 162. The catalyst layer may consist of palladium, platinum, or gold. Following the block 174, electroless (current-free) deposition of a first layer on the catalyst may be performed according to a block 176. The first layer may be nickel.

Following the block 176, electrolytic deposition of a second layer on the first layer may be performed according to a block 177. The second layer may be a copper layer having a thickness in the range of about 0.0001 inch to about 0.001 inch (about 0.00254 mm to about 0.0254 mm), although other suitable conductive materials and/or other layer thicknesses may also suffice. Notably, following deposition of the second layer, the treated outer surface(s) of the polymer support 162 may exhibit the characteristics of a metal (e.g., conductivity), thereby allowing the deposition of one or more metal platings 164 thereon. According to a next block 178, deposition of the metal plating 164 may be achieved using one or more metal deposition processes apparent to those having ordinary skill in the art such as, but not limited to, electroplating, electroless plating, and electroforming. Optionally, additional metal plating layers may be deposited by repeating the block 178 with the same or different metals.

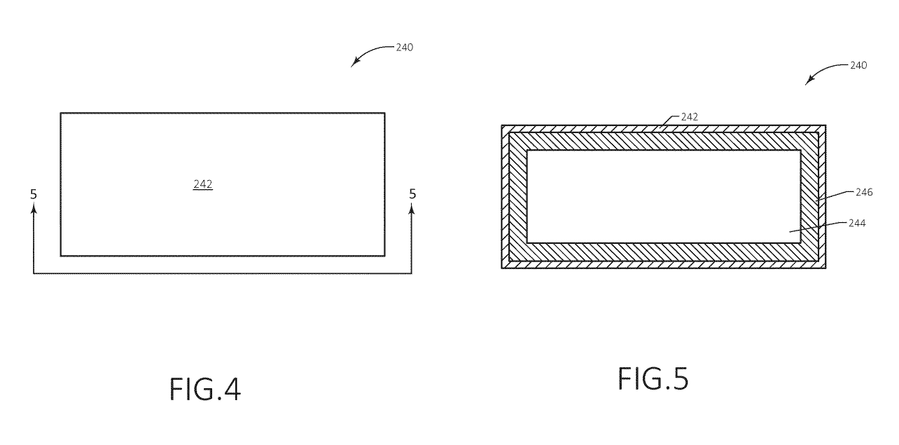

Turning now to FIGS. 4 and 5, a plated polymer component 240 having a temperature-indicating coating 242 is shown. Like the heat-resistant component 160 above, the plated polymer component 240 may be a structural or operative component suitable for use in a range of applications such as, but not limited to, gas turbine engine applications. As non-limiting examples, the plated polymer component 240 may be one of various gas turbine engine parts such as a fan blade, a vane, or a case. As can be appreciated, the component 240 may have any structure suitable for its intended application and, therefore, may deviate substantially from the exemplary box-like structure depicted.

The plated polymer component 240 may consist of a polymer substrate 244 at its core and one or more metal platings 246 applied to one or more outer surfaces of the polymer substrate 244, as best shown in FIG. 5. The temperature-indicating coating 242 may be applied to one or more outer surfaces of the metal plating 246 and/or the polymer substrate 244, as shown. The temperature-indicating coating 242 may respond with a visually-detectable signal at temperatures equal to or greater than a critical temperature or a set of critical temperatures at which the strength of the bond between the metal plating 246 and the polymer substrate 244 begins to weaken. The visually-detectable signal may be an irreversible color change or an obvious change in phase from solid to liquid, although other types of visually-detectable signals are also possible. In this way, an operator may remove the component 240 from service upon visual detection to avoid the possibility of in-service failure.

The temperature-indicating coating 242 may be selected according to coatings which provide a desired signal change at temperatures equal to or near the relevant critical temperature or set of critical temperatures of the component 240. In this way, the critical temperature or set of critical temperatures that leads to weakening of the bond between the metal plating 246 and the polymer substrate 244 may be known in advance so that an appropriate temperature-indicating coating may be selected. Alternatively, as the interfacial bond between the metal plating 246 and the polymer substrate 244 may be structurally weakened at or near the glass-transition temperature of the polymer material(s) forming the polymer substrate 244, the critical temperature or set of critical temperatures of the bond may be approximated from the glass-transition temperature of the polymer material(s) forming the polymer substrate 244. The temperature-indicating coating 242 may be custom-formulated or selected from commercially-available temperature-indicating paints or films which are well-known in the industry.

The polymer substrate 244 may be formed from a thermoplastic and/or thermoset material with optional reinforcement with reinforcing fibers such as carbon fibers or glass fibers. Suitable thermoplastic materials include, but are not limited to, polyetherimide (PEI), thermoplastic polyimide, polyether ether ketone (PEEK), polyether ketone ketone (PEKK), polysulfone, polyamide, polyphenylene sulfide, polyester, polyimide, and combinations thereof. Suitable thermoset materials include, but are not limited to, condensation polyimides, addition polyimides, epoxy cured with aliphatic and/or aromatic amines and/or anhydrides, cyanate esters, phenolics, polyesters, polybenzoxazine, polyurethanes, polyacrylates, polymethacrylates, silicones (thermoset), and combinations thereof. In addition, the polymer substrate 244 may optionally include one or more types of reinforcing materials such as carbon fiber or glass fiber. The metal plating 246 may be formed from any platable material such as, but not limited to, nickel, cobalt, copper, iron, gold, silver, palladium, rhodium, chromium, zinc, tin, cadmium, and alloys of the foregoing elements comprising at least 50 wt. % of the alloy, or combinations thereof.

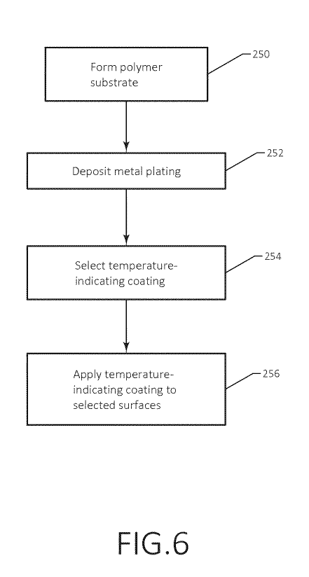

A series of steps which may be performed to fabricate the plated polymer component 240 are illustrated in FIG. 6. According to a first block 250, the polymer substrate 244 may be formed from selected thermoplastic or thermoset materials (with optional fiber reinforcement) in a desired shape using conventional polymer molding processes apparent to those of ordinary skill in the art such as, but not limited to, injection molding, compression molding, blow molding, additive manufacturing (liquid bed, powder bed, deposition processes), or composite layup (autoclave, compression, or liquid molding). One or more metal plating layers 246 may then be applied to selected outer surfaces of the polymer substrate 244 according to a next block 252. The block 252 may involve first suitably activating and metallizing the selected outer surfaces of the polymer substrate 244 using techniques that are well-established in the industry. Once the selected outer surfaces have been suitably activated and metallized, the metal plating layers may be deposited using metal deposition methods apparent to those having ordinary skill in the art such as electrolytic plating, electroless plating, electroforming, or another suitable deposition method. Alternatively, the metal plating 246 may be applied to selected outer surfaces of the polymer substrate 244 as a coating by spraying or other deposition processes.

Based on the known critical temperature or set of critical temperatures of the bond between the metal plating 246 and the polymer substrate 244 (or the glass-transition temperature of the polymer substrate 244), a suitable temperature-indicating coating 242 may be selected according to a block 254, as shown. According to a next block 256, the selected temperature-indicating coating may be applied to selected surfaces of the metal plating 246 and/or outer surfaces of the polymer substrate 244. In this regard, the selected surfaces may be surfaces of the component which have a greater probability for exposure to high temperatures during in-service operation. The temperature-indicating coating 242 may be applied as a film-coating, as a tape, or as a spray coating which is brushed on or painted on, although other application methods may also be used.

### INDUSTRIAL APPLICABILITY

From the foregoing, it can therefore be seen that the present disclosure can find industrial applicability in many situations, including, but not limited to, situations utilizing metal-plated or metal-coated polymer materials which may be exposed to high temperatures or temperatures above their design limits. As disclosed herein, the polymer support structure may be formed from a lightweight polymer and the metal plating(s) applied to its surfaces may substantially contribute to the structural resilience of the component. The introduction of flame-retardant additives into the body of the polymer support may assist in resisting the spread of heat or fire to the heat-sensitive polymeric materials forming the support. As such, this component design strategy may further permit the use of lightweight polymer materials in high-temperature regions of gas turbine engines, and this may result in advantageous improvements in engine efficiency and fuel savings. The technology disclosed herein also provides a metal-plated or metal-coated polymer component having a temperature-indicating outer coating which provides a visually-detectable signal in response to temperatures over the design limits of the underlying component (i.e., the temperature/temperature range at which the interfacial bond between the metal plating and the polymer substrate begins to structurally degrade). As brief over-temperature exposure and resulting interfacial bond damage to plated polymer components may be undetectable in many situations, the temperature-indicating coating provides a low-cost, lightweight, and reliable method for detecting and recording over-temperature exposure to ensure robust and safe performance of plated polymer components in service. The invention described herein may find wide industrial applicability in a wide variety of areas including, but not limited to, automotive parts, wind turbine parts, gas turbine parts, and auxiliary power parts, as well as aerospace, automotive, computer, and military equipment industries.

What is claimed is:

1. A plated polymer component, comprising:
a polymer support;
a metal plating deposited on a surface of the polymer support; and
at least one flame-retardant additive included in the polymer support.

2. The plated polymer component of claim 1, wherein the at least one flame-retardant additive is an intumescent substance.

3. The plated polymer component of claim 2, wherein the intumescent substance forms a carbonaceous solid-phase char layer upon exposure to fire or a heat source, and wherein the carbonaceous solid-phase layer creates a thermal barrier between the polymer support and the fire or the heat source.

4. The plated polymer component of claim 2, wherein the intumescent substance comprises phosphorous, melamine cyanurate, a nanoclay, or a nitrogen compound.

5. The plated polymer component of claim 2, wherein the intumescent substance is present in the polymer support at a concentration in the range of about 5 wt. % to about 10 wt. %.

6. The plated polymer component of claim 2, wherein the polymer support includes a reinforcing element.

7. The plated polymer component of claim 6, wherein the intumescent substance is present in the polymer support at a concentration of greater than about 10 wt. %.

8. A plated polymer component, comprising:
a polymer substrate;
a metal plating deposited on a surface of the polymer substrate; and
a temperature-indicating coating applied to at least one of a surface of the metal plating and the surface of the polymer substrate.

9. The plated polymer component of claim 8, wherein the temperature-indicating coating provides a detectable signal upon exposure of the plated polymer component to a critical temperature, and wherein the critical temperature is a temperature at which a bond between the polymer substrate and the metal plating begins to degrade.

10. The plated polymer component of claim 8, wherein the temperature-indicating coating provides a detectable signal upon exposure of the plated polymer component to a critical temperature, and wherein the critical temperature is a glass-transition temperature of the polymer substrate.

11. The plated polymer component of claim 10, wherein the detectable signal is a visually-detectable signal.

12. The plated polymer component of claim 11, wherein the visually-detectable signal is a color change.

13. The plated polymer component of claim 11, wherein the visually-detectable signal is a phase change.

14. The plated polymer component of claim 13, wherein the phase change is a solid to liquid phase change.

15. The plated polymer component of claim 12, wherein the temperature-indicating coating is a temperature-indicating paint.

16. The plated polymer component of claim 12, wherein the temperature-indicating coating is a temperature-indicating film.

17. A plated polymer component having a polymer substrate and a metal plating deposited on a surface of the polymer substrate, the plated polymer component being formed by a method comprising:
forming the polymer substrate;
depositing the metal plating on the surface of the polymer substrate;
selecting a temperature-indicating coating that provides a detectable signal at a critical temperature of a bond between the polymer substrate and the metal plating; and
applying the temperature-indicating coating to at least one of a surface of the metal plating and a surface of the polymer substrate.

18. The plated polymer component of claim 17, wherein the critical temperature is a glass-transition temperature of the polymer substrate.

19. The plated polymer component of claim 18, wherein applying the temperature-indicating coating comprises applying the temperature-indicating coating as a tape.

20. The plated polymer component of claim 18, wherein applying the temperature-indicating coating comprises applying the temperature-indicated coating as a spray coating.
